(19) United States
(12) Patent Application Publication
(10) Pub. No.: US 2024/0361043 A1
(43) Pub. Date: Oct. 31, 2024

(54) OPTIMIZING SOLAR TRACKER POWER GENERATION

(71) Applicant: NEVADOS ENGINEERING, INC., Oakland, CA (US)

(72) Inventors: Yezin TAHA, San Francisco, CA (US); Kurt RHEE, San Francisco, CA (US)

(73) Assignee: NEVADOS ENGINEERING, INC., Oakland, CA (US)

(21) Appl. No.: 18/644,870

(22) Filed: Apr. 24, 2024

Related U.S. Application Data
(60) Provisional application No. 63/462,793, filed on Apr. 28, 2023.

(51) Int. Cl. F24S 50/20; G05D 3/12; H02S 20/32

(52) U.S. Cl. CPC F24S 50/20; G05D 3/12; H02S 20/32

(57) ABSTRACT

The present invention relates to optimizing power generation of solar trackers. In embodiments of the invention, the optimization may include raycasting solar panels that are near each other and backtracking one or both of them depending on the raycasting results. Such optimization may reduce or eliminate shading of the solar trackers at certain times of day, even solar trackers installed on sloped terrain.

### CROSS REFERENCE TO RELATED APPLICATIONS

This application claims priority to U.S. Provisional Application 63/462,793 titled “OPTIMIZING SOLAR TRACKER POWER GENERATION” filed on Apr. 28, 2023, which is incorporated by reference herein in its entirety.

### FIELD OF THE INVENTION

The invention relates generally to optimizing power generation of solar trackers, specifically utilizing raycasting to optimize tracking schedules of solar trackers.

### BACKGROUND

Two types of mounting systems are widely used for mounting solar panels. Fixed tilt mounting structures support solar panels in a fixed position. The efficiency with which panels supported in this manner generate electricity can vary significantly during the course of a day, as the sun moves across the sky and illuminates the fixed panels more or less effectively. However, fixed tilt solar panel mounting structures may be mechanically simple and inexpensive, and in ground-mounted installations may be arranged relatively easily on sloped and/or uneven terrain.

Single axis tracker solar panel mounting structures allow rotation of the panels about an axis to partially track the motion of the sun across the sky. For example, a single axis tracker may be arranged with its rotation axis oriented generally North-South, so that rotation of the panels around the axis can track the East-West component of the sun's daily motion. Alternatively, a single axis tracker may be arranged with its rotation axis oriented generally East-West, so that rotation of the panels around the axis can track the North-South component of the sun's daily (and seasonal) motion. Solar panels supported by single axis trackers can generate significantly more power than comparable panels arranged in a fixed position.

The amount of grading required to install a single axis tracking system may decrease the economic efficiency of those single axis trackers. Deficiencies in the tracker rotation strategy, which dictate how the trackers follow the sun, may also decrease the efficiency.

Certain single axis trackers are designed specifically to reduce or eliminate the grading requirement by employing specialized bearings that can handle post-to-post net angle changes. A solar array site may have multiple trackers, and each tracker may have multiple bays of solar modules. A bay is a contiguous series of solar modules bounded by posts, and each bay may have its own distinct normal vector. The variability of the normal vectors from bay to bay comes from advantageously reducing the grading requirement, allowing the solar modules to be installed on non-flat, undulating terrain. However, this also makes the trackers more vulnerable to shadowing resulting from cross axis and intra-tracker axis slopes.

A basic tracking algorithm used by many trackers is called true-tracking. Its aim is relatively simple: to minimize the incidence angle between the normal vector of the solar panel and the incoming beam from the sun. Solar panels are lain flat at solar noon and are tilted in early and later in the day to face the sun when it is at low elevation. The steep tilt during certain times may cause shading between trackers, resulting in potentially significant power loss from a pure true-tracking approach. This shading by trackers on other trackers is often referred to as row-to-row shading, since a tracker can be thought of as a row of solar modules, even when there are angle changes within the tracker.

As a result, basic backtracking algorithms were developed to improve on true-tracking. During those times when shading is most likely to be caused in the morning and late evening hours, the angles of the solar modules are reduced (e.g., the modules are made flatter) to prevent shading. These basic backtracking algorithms assume that the trackers are on an entirely flat plane.

More advanced backtracking algorithms, which can be termed cross-slope aware backtracking, take into account that two trackers may each have different planes (higher or lower) in the east or west. The angle between these two planes, called the cross-axis slope, extends infinitely such that all trackers that fall within the scope of each algorithm run will inherit the same cross axis slope. Cross-slope aware backtracking can fail to prevent shading in three ways. First, if the cross-axis slope is not constant throughout the entire site, and there are any slope changes, the algorithm may fail to take those changes into account and prevent row-to-row shading. Second, if the trackers have differing slopes along the tracker axis direction, then the two planes of the trackers are not parallel with one another, which could cause also cause issues. Lastly, even if the slopes in the tracker axis direction are taken into account, such algorithms may only consider the slope tracker as a whole, when there can be changes in slope between the posts within each tracker. These changes can also cause a failure to prevent shading.

### SUMMARY

Embodiments of this invention include optimizing power generation of solar trackers, The optimization may include raycasting solar panels that are near each other and backtracking one or both of them depending on the raycasting results. Such optimization may reduce or eliminate shading of the solar trackers.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

Embodiments of the invention include a method for raycasting a solar site array, comprising: obtaining elevation encoded location points that make up a plurality of bays of the solar site array; calculating a schedule of tracking angles for the bays comprising a plurality of orientations for the bays; spawning a plurality of rays towards a first bay of the bays, the first bay positioned at a first orientation of the orientations in the schedule; intersection testing the second bay of the bays using the rays spawned for the first bay, the second bay being adjacent to the first bay; and backtracking at least one of the first bay and the second bay based on a result of the intersection testing.

The method may have wherein the schedule comprises time steps associated with the tracking angles, spawning the rays is done at a first time step of the time steps that is associated with the first orientation of the first bay, the schedule comprises a second orientation of the orientations associated with the first time step and the second bay, and intersection testing of the second bay is done as the second bay is positioned at the second orientation.

The method may have wherein the schedule comprises a plurality of positions of a sun at the time steps, the positions comprising a first position of the sun at the first time step, and spawning the rays comprises tracing at most two rays from the first position of the sun respectively directed towards two upper corners of the first bay.

The method may have wherein the first orientation is angled with respect to an imaginary horizontal line.

The method may have wherein backtracking positions the first bay at a third orientation different from the first orientation, further comprising: after backtracking, spawning a plurality of second rays towards the first bay positioned at the third orientation, and intersection testing the second bay using the second rays.

The method may have wherein backtracking comprises positioning the first bay at a third orientation and the second bay at a fourth orientation.

The method may have wherein backtracking comprises associating the first time step with the first bay at the third orientation and the second bay at the fourth orientation.

The method may have wherein the third orientation differs from the first orientation by 1-3 degrees towards an imaginary horizontal line.

The method may have wherein intersection testing comprises determining whether any one of the rays intersects the second bay.

The method may have wherein the second bay is directly adjacent to the first bay along an east-west axis.

The method may have wherein the solar site array comprises a first tracker comprising the first bay and a second tracker comprising the second bay, the second tracker being directly adjacent to the first tracker.

The method may further include, after backtracking at least one of the first bay and the second bay: spawning a plurality of third rays towards a third bay of the bays, the third bay positioned at a fifth orientation of the orientations in the schedule, the third bay comprised in the first tracker to be directly adjacent to the first bay; and intersection testing a fourth bay of the bays with the third rays, the fourth bay comprised in the second tracker to be directly adjacent to the second bay.

The method may have wherein the first tracker comprises more than two bays and the second tracker comprises more than two bays, further comprising, after backtracking at least one of the first and the second bay: spawning a plurality of fourth rays towards all remaining bays in the first tracker other than the first bay; and intersection testing all remaining bays in the second tracker other than the second bay with respective ones of the fourth rays.

The method may further include, after backtracking: spawning a plurality of fifth rays towards the first bay positioned at a third orientation of the orientations in the schedule, the third orientation associated with a second time step; intersection testing the second bay using the fifth rays, the second bay positioned at a fourth orientation of the orientations in the schedule, the fourth orientation associated with the second time step; backtracking at least one of the first bay and the second bay based on a result of the intersection testing.

The method may have wherein the schedule comprises a plurality of positions of a sun at the time steps, the positions comprising a first position of the sun at the first time step, and the sun and the second bay are on opposite sides of the first bay in the west-east axis.

Embodiments of the invention may include a non-transitory, computer-readable storage medium storing computer-readable instructions which, when the instructions are executed on a processor, cause the processor to perform operations comprising: obtaining elevation encoded location points that make up a plurality of bays of the solar site array; calculating a schedule of tracking angles for the bays comprising a plurality of orientations for the bays; spawning a plurality of rays towards a first bay of the bays, the first bay positioned at a first orientation of the orientations in the schedule; intersection testing the second bay of the bays using the rays spawned for the first bay, the second bay being adjacent to the first bay; and backtracking at least one of the first bay and the second bay based on a result of the intersection testing.

The non-transitory computer-readable medium may have wherein the schedule comprises time steps associated with the tracking angles, spawning the rays is done at a first time step of the time steps that is associated with the first orientation of the first bay, the schedule comprises a second orientation of the orientations associated with the first time step and the second bay, and intersection testing of the second bay is done as the second bay is positioned at the second orientation.

The non-transitory computer-readable medium may have wherein the schedule comprises a plurality of positions of a sun at the time steps, the positions comprising a first position of the sun at the first time step, and spawning the rays comprises tracing at most two rays from the first position of the sun respectively directed towards two upper corners of the first bay.

The non-transitory computer-readable medium may have wherein the first orientation is angled with respect to an imaginary horizontal line.

The non-transitory computer-readable medium may have wherein backtracking positions the first bay at a third orientation different from the first orientation, further comprising: after backtracking, spawning a plurality of second rays towards the first bay positioned at the third orientation, and intersection testing the second bay using the second rays.

### BRIEF DESCRIPTION OF THE DRAWINGS

FIG. 1 shows an example of an all-terrain solar tracker arranged on sloped and rolling terrain with angle changes along its length to follow the natural terrain.

FIG. 2 shows a perspective view of a solar site array with two neighboring trackers and two bays of solar modules each.

FIG. 3 shows a cross section of a single tracker with three bays of solar modules on an upward slope extending along the North-South axis.

FIG. 4 shows a cross section of a solar site array with three trackers neighboring each other along the East-West axis.

FIG. 5 depicts a flow diagram illustrating a raycasting process to prevent shading in a solar site array.

FIG. 6 depicts raycasting done on two bays where an intersection test is performed on one of the two bays.

FIG. 7 shows a block diagram of a computer system in communication with a solar panel array.

FIG. 8 shows a block diagram of a solar panel control system in communication with a solar panel array.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention.

As used in this specification and the appended claims, the singular forms “a,” “an,” and “the” include plural referents unless the context clearly indicates otherwise. Also, the term “parallel” is intended to mean “substantially parallel” and to encompass minor deviations from parallel geometries. The term “vertical” refers to a direction parallel to the force of the earth's gravity. The term “horizontal” refers to a direction perpendicular to “vertical.”

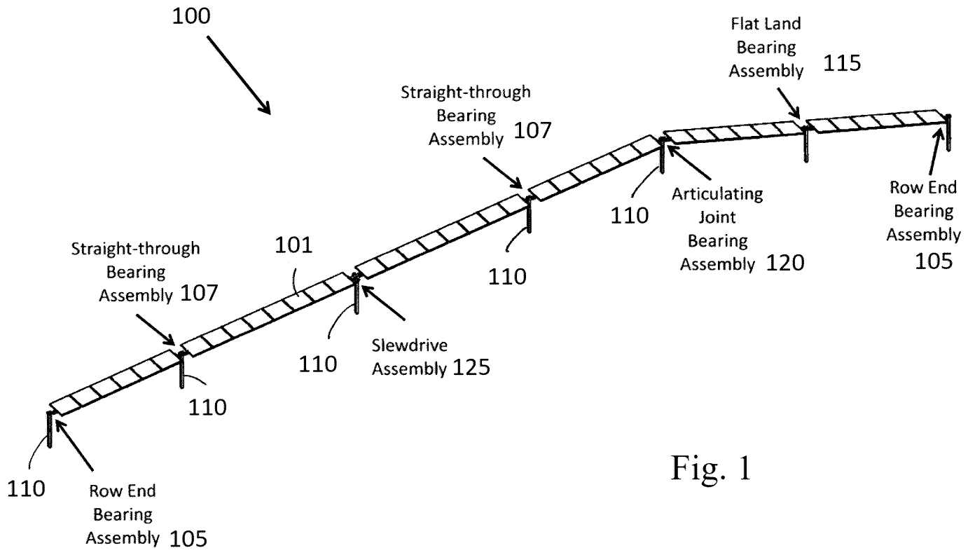

FIG. 1 illustrates an example variable terrain solar tracker 100, which employs support posts 110, solar module supports such as torque tubes extending between the support posts, and solar modules 101 supported by the torque tubes (the term solar “modules” and solar “panel” may be used interchangeably in this description). Multiple solar modules may be between each of the support posts, and they may all be of a same size as one another. The number of solar modules between each of the support posts may be the same along the tracker, or it may vary depending on the terrain and the spacing of specific support posts.

This example variable terrain solar tracker is arranged on uneven terrain and includes two rotation axes: a first rotation axis arranged along a slope, and a second horizontal rotation axis along a flat portion of land above the slope. The angle between the first rotation axis and the second horizontal rotation axis may be, for example, ≥0 degrees, ≥5 degrees, ≥10 degrees, ≥15 degrees, ≥20 degrees, ≥25 degrees, ≥30 degrees, ≥35 degrees, ≥40 degrees, ≥45 degrees, ≥50 degrees, ≥55 degrees, ≥60 degrees, ≥65 degrees, ≥70 degrees, ≥75 degrees, ≥80 degrees, ≥85 degrees, or up to 90 degrees. These examples refer to the magnitude of the angle between the first rotation axis and the second horizontal axis. The angles may be positive or negative.

Various types of assemblies may be disposed on top of support posts, depending on the terrain and the position of the support post with relation to the rest of the trackers: straight-through bearing assemblies for sloping planar surfaces, flat land bearing assembly for flat land, row end bearing assembly for an end of a the tracker, articulating joint bearing assembly for changing terrain angles, and drive device assembly at an end of the tracker or an intermediate position along the tracker in order to drive rotation of the tracker.

For example, opposite ends of the tracker are rotationally supported by row end bearing assemblies 105 on support posts 110. The portion of the tracker arranged on the slope is supported by straight-through bearing assemblies 107, which include thrust bearings that isolate and transmit portions of the slope load to corresponding support posts 110. The portion of the tracker arranged on flat land, above the slope, is rotationally supported by a flat land bearing assembly 115 which may be a conventional pass-through bearing assembly lacking thrust bearings as described above. The drive device may be a slew drive that drives rotation of the solar modules 101 about the first and second rotation axes to track the sun. The solar modules 101 may be supported on torque tubes that are parallel with and optionally displaced (e.g., displaced downward) from the rotation axis of the slew drives. The torque tubes may also be aligned with rather than displaced from the rotation axis of the slew drives. Articulating joint bearing assembly 120 links the two non-collinear rotation axes and transmits torque between them. Example configurations for bearing assemblies 105, 107 and 120 are described in more detail below.

Other variations of the variable terrain solar tracker 100 may include other combinations of bearing assemblies 105, 107, 115, and 120 arranged to accommodate one, two, or more linked rotational axes arranged along terrain exhibiting one or more sloped portions and optionally one or more horizontal (flat) portions. Two or more such trackers may be arranged, for example next to each other in rows, to efficiently fill a parcel of sloped and/or uneven terrain with electricity-generating single axis tracking solar panels.

Referring again to FIG. 1, as noted above articulating joint bearing assembly 120 accommodates a change in direction of the rotational axis along the tracker. As used herein, “articulating joint” refers to a joint that can receive torque on one axis of rotation and transmit the torque to a second axis of rotation that has a coincident point with the first axis of rotation. This joint can be inserted between two spinning rods that are transmitting torque to allow the second spinning rod to bend away from the first spinning rod without requiring the first or second spinning rod to flex along its length. One joint of this type, which may be used in articulating joint bearing assemblies as described herein, is called a Hooke Joint and is characterized by having a forked yoke that attaches to the first spinning rod, a forked yoke attached to the second spinning rod, and a four-pointed cross between them that allows torque to be transmitted from the yoke cars from the first shaft into the yoke cars of the second shaft.

A solar panel array control system may be provided, which may control operation of one or more solar panels in the solar array. Operation of the one or more solar panels may include positioning of the one or more solar panels. For example, the solar panel array control system may control an orientation of one or more solar panels. The control system may send signals to a solar panel supporting structure, which may affect the position of the one or more solar panels. The articulating joint may be capable of allowing a position of a solar panel to be controlled from the control system. The solar panel support structure affecting position of the one or more solar panels may include a slew drive and a controller directing the slew drive.

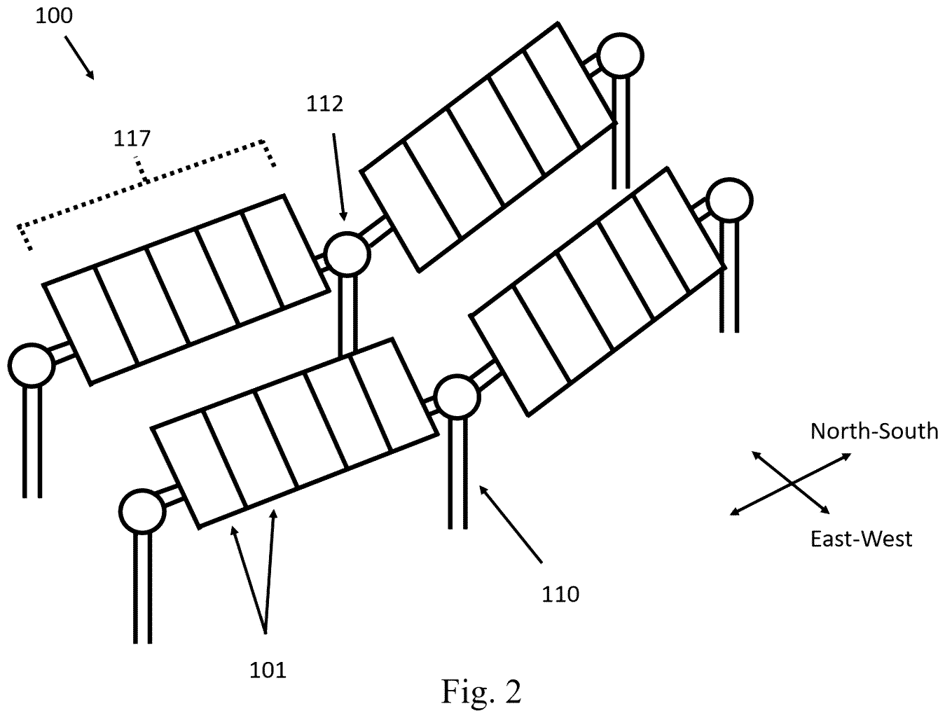

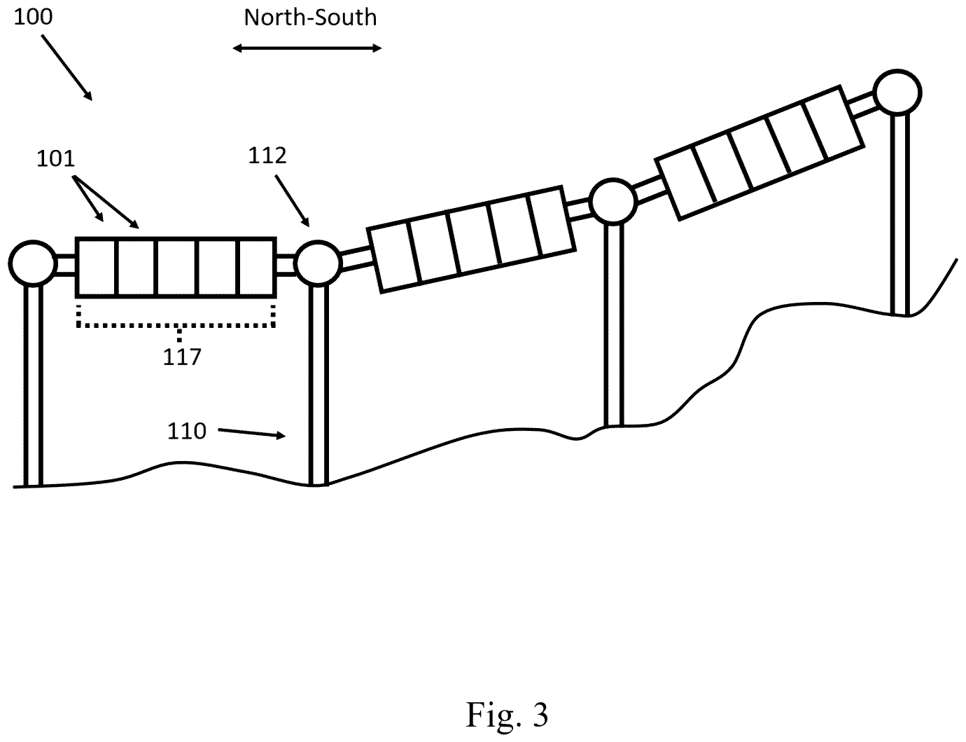

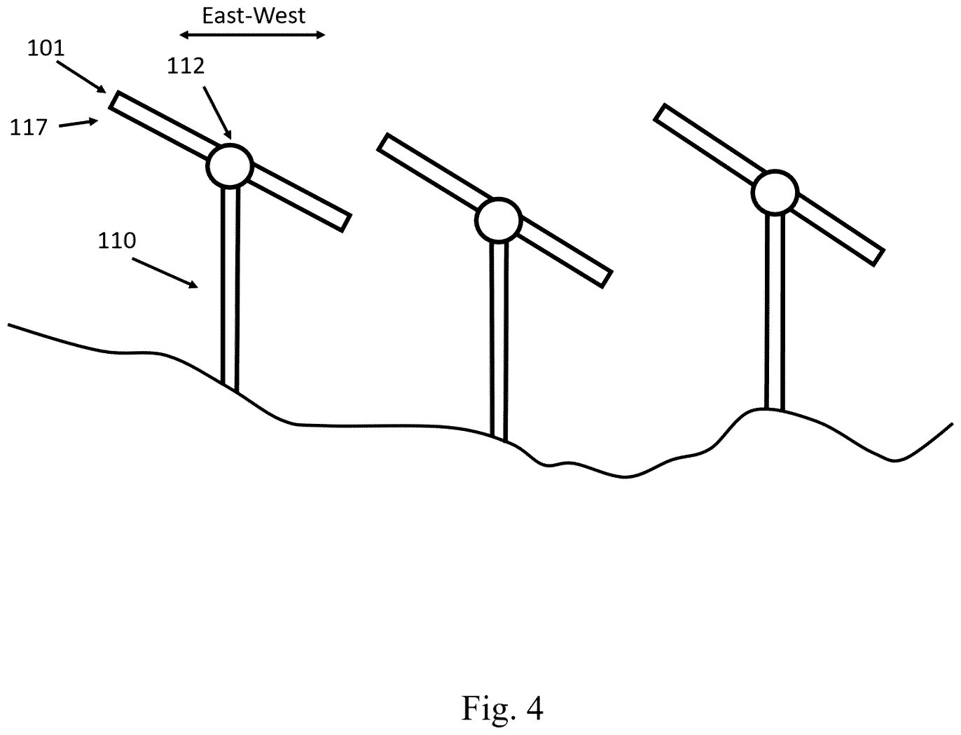

FIGS. 2-4 illustrate a solar site array or part of a solar site array. FIG. 2 depicts two trackers in the solar site array directly adjacent to each other, each running along or approximately along the north-south direction with solar modules extending lengthwise in or approximately in the east-west direction. Alternatively, the trackers may run along or approximately along the east-west direction with solar modules extending lengthwise in or approximately in the north-south direction. An angle change is depicted in both trackers at the bearing assembly 112. Bearing assemblies 112 disposed on a support 110 could be any of the bearing assemblies described above, such as an articulating bearing assembly. A bay 117 includes a series of solar modules disposed directly adjacent to each other. The bay 117 may be bounded by bearing assemblies 112 and disposed on a single torque tube. A single bay 117 may have solar modules 101 that have parallel normal vectors and also lie on a same plane as each other, which holds true even as the torque tube rotates the solar modules. FIG. 3 depicts a cross section of a solar site array looking along the east-west axis. A single tracker with three bays 117 is depicted from the solar site array. FIG. 4 depicts a cross section of a solar site array looking along the north-south axis. Three trackers of the solar site array are depicted side by side on the sloped landscape. The solar modules 101 in the bays 117 are tilted away from the horizontal. As evident from the figure, it is possible for directly adjacent trackers (i.e., neighboring trackers) along the east-west axis to shade each other with their bays 117.

In order to prevent shading, backtracking may be employed. The angles at which to backtrack can be obtained from a raycasting process.

To start the raycasting process, elevation encoded location points of a particular solar array site need to be obtained. For example, the 3D geometry may be constructed using the tracker layer drawn in CAD, and the elevation encoded location points obtained from that construction. These points may describe a set of rectangular polygons. Each rectangular polygon encloses a contiguous set of solar modules sharing a common plane and having parallel normal vectors. For example, each set of the rectangular polygons may form a rectangular prism that encloses a bay. Alternatively, the elevation encoded location points may form an arbitrary polyhedron that is not necessarily a rectangular prism. A tracker may be made up of multiple bays of solar modules. Each bay may be a grouping including one or more solar modules. Each bay may be disposed on a torque tube. Each bay may be between two bearings and/or foundations that allow angular change from bay to bay, whether that angular change is in the North-South or the East-West direction. Each bay may extend beyond two bearings and/or foundations and be defined by a length of section of torque tube with a starting and ending point at different slope angles from the identified bay.

Sun angles are determined for the elevation encoded location points, then a schedule of true tracking angles are created for each tracker.

True tracking angles may be obtained by maximizing the irradiance collected through minimizing its incident angle on the solar module with the normal of the solar module. Single-axis trackers generally do not face directly towards the sun (e.g. the sun is south of the tracker) so the incident angle of the sun's beam is minimized by matching the solar module normal to the projection of the sun's position on the plane swept by the solar module normal over its entire range of motion. This matching solar module normal is the true tracking angle of the tracker, which changes throughout the day to create the schedule of angles.

By themselves, these true tracking angles may undesirably cause solar modules from neighboring trackers to shade each other when the sun is low in the sky in the morning and/′or evening, resulting in a large amount of power lost. Obtaining backtracking angles allows the trackers to avoid shading each other while sticking as closely as possible to the true tracking angles. These backtracking angles may be obtained by the raycasting process.

Using the schedule of true tracking angles, the sun's orientation with respect to each rectangular polygon—i.e., each bay of solar modules—is known. The schedule includes true tracking angles for each time step throughout the time period of interest, such as an entire day, an entire month, or entire year.

To begin raycasting, light may be traced directly from the sun (e.g., modeled computationally) as a light source to each bay. In the simplest incantation of a backwards ray tracing program such as those used in the movie and video game industries, rays are traced from a “camera” (e.g., a virtual sensor), through the pixels on a screen and into the scene and then finally towards a light source. Because a realistic image is not necessary to determine if a shadow is cast by the direct light from the sun, we can remove the camera and screen objects from our problem and trace the light from the light source (the sun) instead of towards it. First a particular starting tracker is chosen to define the direction of spawned light rays. The starting tracker may be the westernmost or easternmost tracker for an entire array of trackers on a site. The starting tracker may be on the opposite side of the sun or the furthest tracker from the sun in the array. In a first example, in the morning when the sun rises in the east, the westernmost tracker may be chosen as the starting tracker. Alternatively, the starting tracker does not have to be furthest from the sun, and may be chosen to be closest to the sun or neither closest nor furthest from the sun.

For this starting tracker, a set of light rays can be spawned for each bay in the tracker. To decrease total computation time, each ray can be defined by an origin corresponding to the corner of the bay and a direction corresponding to the unit vector coming from the direction of the sun. At a minimum two rays from the sun may be spawned for each bay directed to the upper two corners of that bay, e.g. the northern and southern corners furthest from the ground in a vertical direction when the solar module is tilted at any angle greater than 0 degrees (so that it is not parallel with the ground). With just these two rays spawned towards the upper corners, a reasonably accurate if not perfect assessment of whether shading occurs may be obtained, while saving on processing time compared to if many more rays were spawned. If neither of these two rays hits a bay behind the spawning bay, then it is less likely other rays spawned towards the starting tracker will intercept a bay behind the starting tracker. These two rays can thus indicate there will likely not be shading. If either of the two rays hit, then a ray in between them would also be hitting, so that shading can be determined without spawning more than two rays. In this optimization rays for the bottom two corners of the spawning bay do not need to be spawned. However, this is not a requirement, and any number of rays from two to millions of rays may be spawned for each bay. For example, more than 2 rays may be spawned for the upper edge of the bay 4 or less rays, such as 16 or less rays, such as 256 or less rays, such as 65536 or less rays. More rays may require more computational power and/or time but provide more certainty on whether or not shading is occurring. In the instance where more than two rays are spawned, the upper corners may still each have a ray spawned, with additional rays spawned on the upper edge of the bay in between the upper corners. However, this is not a requirement, and rays may be spawned at other edges of the bay, or within the body of the bay not on an edge.

The rays spawned may be spawned in the sense of taking a limit of a light ray approaching the corner of the spawning bay. In a physical sense, these rays may be partially blocked in real life depending on quantum theory, but in a classical sense they do not get blocked and glance the corners of the spawning bay to travel to the bay behind the spawning bay.

Once the rays are spawned towards the spawning bay, their trajectories as they relate to any bays behind the spawning bay are known. These bays may be on the tracker directly adjacent to the tracker of the spawning bay. They may also be on an opposite side of the sun with respect to the spawning bay. These bays are of interest because they may be shaded by the spawning bay. In other words, they are in the “field-of-view” of the spawning bay such that a light ray spawned towards the spawning bay may potentially intersect these other bays, which will be referred to as field-of-view bays. Intersection tests may be performed for these field-of-view bays. If the spawned rays intersect the field-of-view bay, the intersection test is positive. When the intersection test is positive, this means the spawning bay is shading the field-of-view bay at that time step.

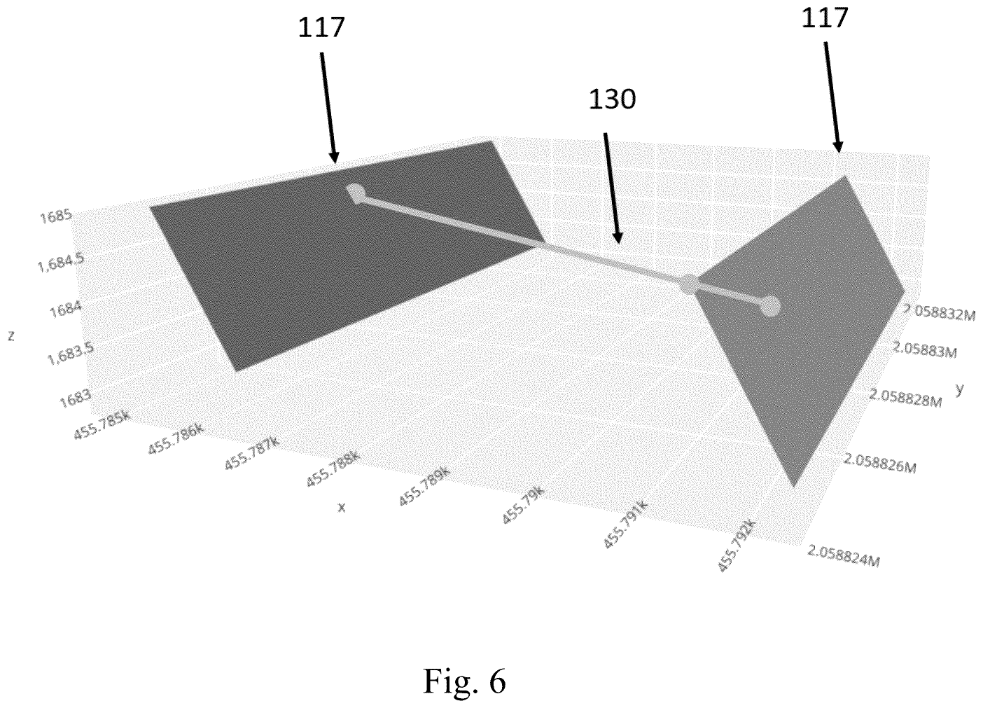

FIG. 6 depicts a ray 130 being spawned towards a first bay 117 (on the top of the page) and intersection tested with a second bay 117 (bottom of the page), both of which are angled away from the horizontal. The axes represent three dimensions of positions that the bays and ray inhabit. The sun from which the ray 130 is traced (not shown) is positioned towards the top of the page. The ray 130 is traced towards one of the upper corners of the first bay 117 and glances that corner (on the page, the direction of gravity is right). The ray 130 intersects with the second bay 117. This positive result for the intersection test means that at these angular orientations of the first and second bays 117, the first bay 117 shades the second bay 117.

Accordingly, the tracker of the spawning bay, the tracker of the shaded bay, or both trackers can be backtracked by a predetermined amount (e.g., 1-5 degrees, e.g., 1-3 degrees, such as 1 degree). Backtracking may occur after all spawning bays in a single tracker are tested, or after the first and/or each spawning bay in a single tracker is tested. Backtracking means to tilt the solar panels closer to flat or horizontal, e.g., closer to parallel with respect to an ungraded surface of the earth, or closer to parallel with a direction that is perpendicular to the earth's gravity. Both trackers may be backtracked the same amount or they may be backtracked different amounts. In embodiments of the invention, once both trackers are backtracked, raycasting as described above to test for any shading still occurring is done again until no shading occurs. Accordingly, new rays may be spawned on the backtracked spawning bay and an intersection test performed on the backtracked field-of-view bay(s), and if there is still shading, then the trackers for both bays are backtracked again a predetermined amount. This cycle of raycasting and backtracking may be repeated for as long as it takes until the spawning bay no longer shades any field-of-view bays.

Rays spawned by the spawning bay may be intersection tested with respect to more than any field-of-view bays depending on how many bays are in the field-of-view of the spawning bay. In certain sites depending on the terrain and other considerations, each bay in a tracker may not be perfectly aligned to bays in neighboring trackers, misalignment as referred to in the cross axial east to west direction. The northernmost and southernmost points of the spawning bay may bound the spawning bay's field of view (the field of view is given a limited definition here for the sake of optimization). Any neighboring bay behind the spawning bay with a northernmost or southernmost point between the spawning bay's field of view in the cross axial direction is considered a relevant field-of-view bay for intersection testing. For example, a first neighboring bay has its southernmost point in between the spawning bay's northernmost and southernmost points and a second neighboring bay has its northernmost point in between the spawning bay's northernmost and southernmost points. Even though the first neighboring bay's northernmost point is not in between the spawning bay's northernmost and southernmost points and the second neighboring bay's southernmost point is not between the spawning bay's northernmost and southernmost points, both the first and second neighboring bays are considered field-of-view bays that will be intersection tested.

The definition of the field-of-view may be expanded from that given above when accuracy is valued over computational speed and/or case. For example, the spawning bay may have a field-of-view that not only includes any neighboring bay within the northernmost and southernmost point in the cross axial direction, but also includes any bays neighboring the neighboring bay in the axial direction (i.e., on the same tracker as the neighboring bay). Thus the intersection testing mentioned below could not only be done for the neighboring bay of the spawning trackers, but also those additional bays next to the neighboring bay. This field-of-view definition can be even further expanded to include more bays. For example, the field-of-view of the spawning bay can include not just the neighboring bay and those bays next to the neighboring bay, but may include all the bays in the tracker of the neighboring bay. For example, the field-of-view can include all the bays in the neighboring tracker, and all the bays adjacent to the neighboring tracker opposite the neighboring tracker from the tracker of the spawning bay. For example, the field-of-view can include all the bays in the solar site other than the bays in the tracker of the spawning bay, and other than the bays in trackers closer to the sun than the spawning tracker (e.g., closer as measured only in consideration of the east-west component). Each of these bays in the field-of-view may be intersection tested by the spawning bay as discussed below.

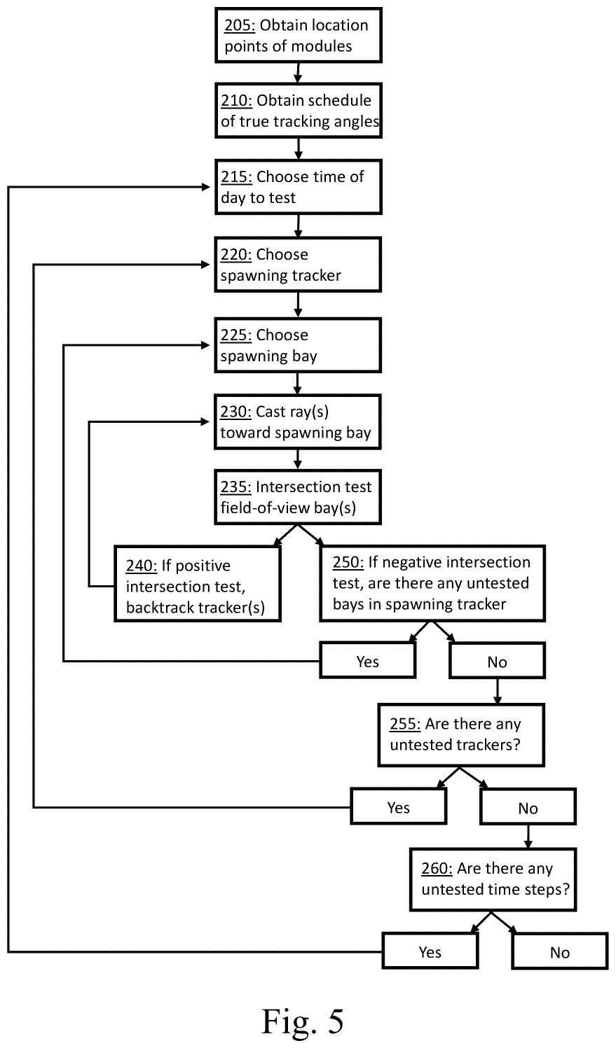

FIG. 5 depicts the method of raycasting in flow chart form. At 205, obtain the location points of modules. A solar module site which has either been physically installed at a physical site, or virtually built and modelled, is chosen for raycasting. The site may be an array of solar modules. The array may include trackers of solar modules, each of which include multiple bays of solar modules, where each bay may have one or more solar modules. Elevation encoded location points of the solar modules in the site are obtained. This may include getting location points for every bay of every tracker in the site, or only a portion of solar modules in the site. Each of these location points may describe a set of rectangular polygons. Each rectangular polygon encloses and/or represents a bay in the tracker.

At 210, obtain a schedule of true tracking angles. Once the elevation encoded locations points of the site are known, the schedule of true tracking angles may be obtained. The schedule may include the angle of some or every bay and/or tracker for each time step. The schedule may be in uniform time steps spaced out in equal intervals. The time steps may, for example, be in intervals of five minutes and span for at least an entire day, week, month, or year. Of course, the time steps and span may be any arbitrary time interval, and the time steps themselves may alternatively be nonuniform, for example to be more granular at more important times of the day compared to other times.

At 215, choose the time of day to test. The time is chosen from the schedule of true tracking angles. This choice may be made sequentially. For example, when starting testing, the chronologically earliest time may be chosen. Generally, the choice of the next time of day to test is the next untested chronological time step in the schedule. Of course, this is not necessary, and arbitrary times of day may be chosen for testing, depending on times of particular interest.

At 220, choose a spawning tracker (also referred to as a starting tracker in this description). The spawning tracker is defined as the tracker containing the spawning bay which will generate the rays for raycasting. When starting testing, the spawning tracker may be chosen from one extreme of the western and eastern side, such as the westernmost or easternmost tracker. Otherwise, the spawning tracker may be chosen from an untested tracker (e.g., untested in the current time step) directly adjacent to the last tested tracker. Alternatively, a non-tracker object, such as a tree, rock, or inverter, may be chosen as a substitute for the spawning tracker in at least parts of this method, to model the effects of a non-tracker object shading a neighboring bay as described below.

At 225, choose a spawning bay from the spawning tracker. When no other bay in the spawning tracker has yet been tested, the spawning bay may be chosen from the northernmost or southernmost bay. If any bays in the tracker have been tested, the next spawning bay may be chosen from an untested bay (e.g., untested in the current time step) directly adjacent to the last tested bay. For example, at the beginning of testing the spawning bay may be chosen as the northernmost bay, then after testing is done at the bay directly south of it may be chosen for testing.

At 230, perform raycasting for the chosen spawning bay. This may involve casting at least two rays from the sun towards the upper corners of the bay, as described above.

At 235, the spawned rays are used to intersection test with at least one neighboring bay to the spawning bay. The neighboring bay may be on a tracker directly adjacent to the spawning tracker in the cross-axial direction. The neighboring bay may be on the opposite side of the spawning tracker as the sun, in the cross axial direction. More than one of the neighboring bays are tested if at least some part of the neighboring bays are directly adjacent to the spawning bay. The next part of the method depends on the results of the intersection test. If the intersection test is positive, proceed to 240 and backtrack at least one of the involved trackers. For example, both the spawning tracker and the neighboring tracker which gave the positive intersection test may be backtracked. In embodiments of the invention, only one of the spawning tracker and the neighboring tracker may be backtracked. This backtracking may include modifying the schedule so that the resulting angle of the spawning and/or neighboring tracker replaces the true tracking or previous angle associated with the relevant time step. In any case, after backtracking, proceed to 230 once again, where rays are cast towards the (backtracked) spawning bay. Again at 235, the intersection test of these newly spawned rays are intersection tested with the (backtracked) neighboring tracker. This process may be repeated until the (iteratively backtracked) neighboring tracker gives a negative intersection test with the rays spawned towards the (iteratively backtracked) spawning bay.

Once the neighboring tracker gives a negative intersection test, 250 determines whether there are any untested bays in the spawning tracker, i.e., any bays for which rays have not been spawned for yet during this particular time step in the true tracking schedule. If there are, proceed to 225 where the next spawning bay is chosen. The spawning bay may be chosen in a sequential fashion as described above, or alternatively may be chosen arbitrarily from the remaining untested bays.

If there are no untested bays in the spawning tracker left, then 255 determines whether there are any untested trackers in the entire solar array site, i.e., whether there are any trackers for which none of its bays has been put through raycasting for this particular time step in the schedule. If there are, proceed again to 220 and choose the next spawning tracker as described above. If there are not, then proceed to 260 and determine whether there are any untested time steps in the schedule of true tracking angles, i.e., whether there are any time steps for which none of the bays in the site have been raycasted. If there are, choose the next time step in the schedule to test at 215, e.g., the chronologically next time step after the just tested time step. If there are not, then the method may complete.

Due to the fact that ray tracing is a time consuming process, a number of methods can be implemented so that the problem solves in a reasonable amount of time. These include reducing the amount of intersection tests required by choosing only reasonable objects that could possibly block direct irradiance, and having the raytracing processes run in parallel. For example, multiple instances of the method depicted in FIG. 5 may be run at once, for example on multiple processors or multiple computers. For example, the solar site may be divided into zones, and the method of FIG. 5 may be run in parallel for each zone.

In this way, utilizing raycasting on a solar site with a predetermined schedule of tracking angles may lead to a modified schedule of tracking angles that leads to increased power generation over the predetermined schedule. The methods used to increase power generation are particularly advantageous over previous methods because they may be used for a virtual site of solar trackers that has not been built yet, allowing a better determination of power generation of particular sites before a potentially costly commitment of installing solar trackers at the site.

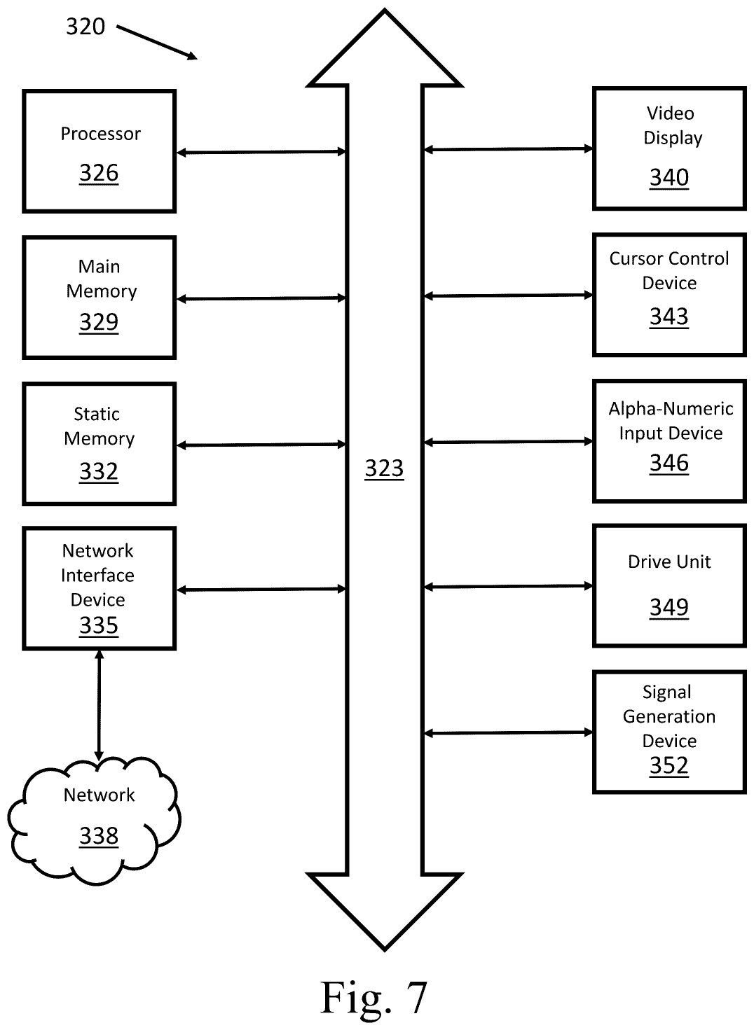

FIG. 7 is a block diagram of a machine in the example form of a computer system 320 within which instructions for causing the machine to perform any one or more of the methodologies discussed herein may be stored and/or executed. The machine may operate as a standalone device or may be connected (e.g., network) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 320 may include a processor 326 (e.g., a central processing unit (CPU), a graphics processing unit (GPU) or both), a main memory 329 and a static memory 332, which communicate with each other via a bus 323. The computer system 320 may further include a video display unit 340 (e.g., a liquid crystal display (LCD) or a cathode ray tube (CRT)). The computer system 320 also includes an alphanumeric input device 346 (e.g., a keyboard), a user interface (UI) navigation (or cursor control) device 343 (e.g., a mouse), a disk drive unit 349, a signal generation device 352 (e.g., a speaker) and a network interface device 335 connected to a network 338.

The disk drive unit 349 (e.g., a hard disk) may include a computer-readable medium on which is stored one or more sets of data structures and instructions (e.g., software and/or algorithms) embodying or utilized by any one or more of the methodologies or functions described herein. The instructions may also reside, completely or at least partially, within the main memory 329 and/or within the processor 326 during execution thereof by the computer system 320, the main memory 329 and the processor 326 also may constitute machine-readable media. The instructions may also reside, completely or at least partially, within the static memory 332.

The term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks. Machine-readable media may also include random access memory (RAM) (such as dynamic RAM (DRAM) and static RAM (SRAM)).

The instructions may further be transmitted or received over a communications network 338 using a transmission medium. The instructions may be transmitted using the network interface device 335 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software. The network interface device 335 may include one or more modems, network interface cards, wireless network interfaces or other interface devices, such as those used for coupling to Ethernet, token ring, or other types of networks.

Embodiments of the computer system may not require every element illustrated in FIG. 7 to be present, such that elements depicted in FIG. 7 may be optional. For example, an embodiment of a computer system used to implement embodiments of the invention may not include a signal generation device 352 or a cursor control device 343.

Some portions of the detailed description herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, and each coupled to a computer system bus.

The algorithms presented herein are not inherently related to any particular computer or other apparatus. Various general purpose systems, messaging servers, or personal computers may be used with programs in accordance with the teachings herein, or it may prove convenient to construct a more specialized apparatus to perform the required method steps. The required structure for a variety of these systems appears in the description above. A variety of programming languages may be used to implement the teachings of the disclosure as described herein.

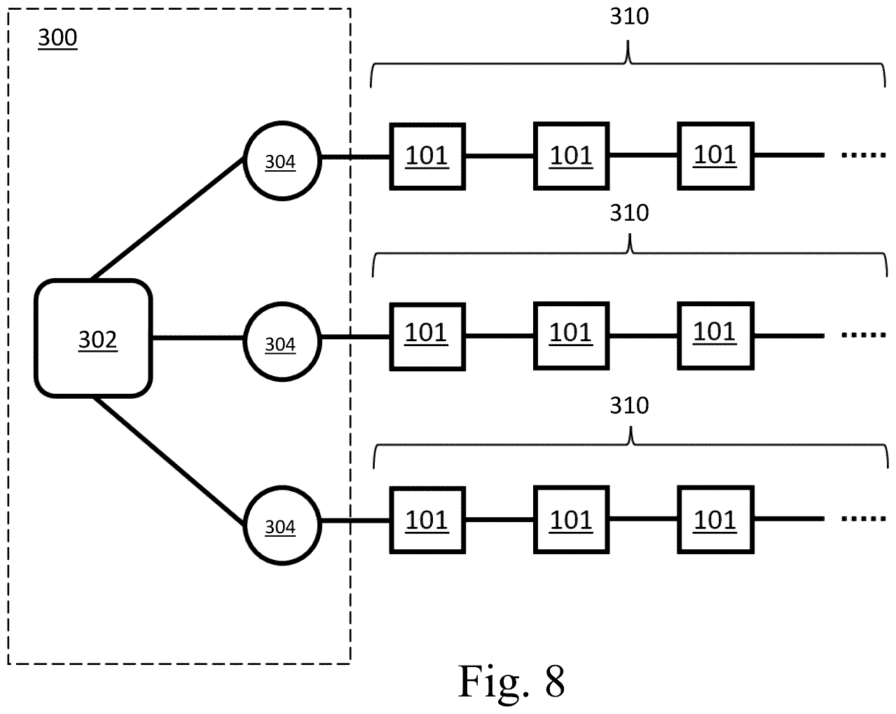

FIG. 8 shows an example of a solar panel array control system 300 coupled to a solar panel array. The solar panel array control system 300 may communicate with the solar panel array. The solar panel array control system 300 and/or elements of the solar panel array control system 300 (such as the central controller 302 and/or group control systems 304) may include, be included in, or consist of the computer system 320 or elements of the computer system 320 described above.

The solar panel array may include one or more solar panel groups 310 each including one or more solar panel modules 101. The groups 310 may include one or more solar panels connected in series, in parallel, or any combination thereof. The solar panel groups may include rows of solar panels, and may be trackers 100 as described above. Any description herein of rows of solar panels may apply to any other type of arrangement or grouping of solar panels.

Optionally, each group of solar panels may each have (e.g., be coupled to and in communication with) a group control system 304. Each group control system 304 may control operation their respective solar panel group 310. The group control systems 304 may be referred to as row controllers when controlling rows of solar panels. Any number of solar panel groups and/or group control systems may be provided. Each group may comprise any number of solar panels. Each group may have the same number of solar panels or differing numbers of solar panels. A central controller 302 may optionally be provided that may control the group control systems.

The solar panel array control system 300 may comprise the central controller 302 and, optionally, one or more group control systems 304. In some instances, one-way communication may be provided from the central controller to the one or more group control systems. The central controller may send instructions to the one or more group control systems, which may in turn control operation of the corresponding solar panel groups. In some instances, two-way communication may be provided between the central controller and the one or more group control systems. For instance, the group control systems may be group controllers that may send data to the central controller. The central controller may send instructions to the group controllers, for example in response to, or based on, the data received from the group controllers. The data from the one or more group controllers may optionally include data from one or more solar panels, or various types of sensors physically included as part of the solar panel group (e.g., on a torque tube, foundation, bearing assembly, or other part of the tracker), physically remote from the solar panel group, and/or otherwise physically or electrically coupled to the solar panel group.

The solar panel array control system may direct and affect operation of the solar panels, which may include positioning of the solar panels. The control system may affect an orientation of the solar panel. The control system may control amount of rotation, rate of rotation, and/or acceleration of rotation of one or more solar panels. The control system may affect a spatial disposition of the solar panel. The control system may control an amount of translation, speed of translation, and/or acceleration of translation of one or more solar panels. The control system may affect operation of one or more driving mechanisms for a solar panel array, for example by sending signals to the slew drive coupled to one or each of the solar panel groups, which may then control orientation of the solar panels. The solar panels may be positioned in response to one or more factors, as previously described herein. The solar panel array control system may affect other operations of the solar panels, such as turning the solar panels on or off, operational parameters of converting the solar energy to electrical energy, diagnostics, error detection, calibration, or any other type of operations of the solar panels.

In one example, a method of optimizing power generation throughout a field of trackers may be provided. Operational data for each grouping (e.g., each row) of solar panels may be provided. Any description herein of a row may apply to any grouping. The method may include collecting row-level operational data in aggregate, or piecemeal, to determine the operational characteristics of one or more rows of trackers. Power generation data of each row may be measured to determine if shading is occurring from one row to the next. The method may include analyzing total field power generation to determine if shading specific rows, while further optimizing or adjusting the tilt of other rows for generating power, will increase overall field power generation.

Row-level tests may be performed to determine the impact of shading of one or more rows on the one or more neighboring rows with regard to power generation of the neighboring rows. Row-level tests may be performed on one or more rows to determine if an optimum orientation assumption yields optimum or increased power generation. Tracking schedules may be updated to optimize or increase power generation throughout a tracker field or for each individual row. Row-level power generation may be monitored and compared with weather station reports to determine if sun-tracking operations or non-sun-tracking operations will yield greater power generation. Based on the comparison, an operation may be selected to yield the greater power generation.

This disclosure is illustrative and not limiting. Further modifications will be apparent to one skilled in the art in light of this disclosure and are intended to fall within the scope of the appended claims.

1. A method for raycasting, comprising:
obtaining elevation encoded location points that make up a plurality of bays of a solar site array;
calculating a schedule of tracking angles for the bays comprising a plurality of orientations for the bays;
spawning a plurality of rays towards a first bay of the bays, the first bay positioned at a first orientation of the orientations in the schedule;
intersection testing the second bay of the bays using the rays spawned for the first bay, the second bay being adjacent to the first bay; and
backtracking at least one of the first bay and the second bay based on a result of the intersection testing.

2. The method of claim 1, wherein the schedule comprises time steps associated with the tracking angles, spawning the rays is done at a first time step of the time steps that is associated with the first orientation of the first bay, the schedule comprises a second orientation of the orientations associated with the first time step and the second bay, and intersection testing of the second bay is done as the second bay is positioned at the second orientation.

3. The method of claim 2, wherein the schedule comprises a plurality of positions of a sun at the time steps, the positions comprising a first position of the sun at the first time step, and spawning the rays comprises tracing at most two rays from the first position of the sun respectively directed towards two upper corners of the first bay.

4. The method of claim 1, wherein the first orientation is angled with respect to an imaginary horizontal line.

5. The method of claim 1, wherein backtracking positions the first bay at a third orientation different from the first orientation, further comprising:
after backtracking, spawning a plurality of second rays towards the first bay positioned at the third orientation, and intersection testing the second bay using the second rays.

6. The method of claim 1, wherein backtracking comprises positioning the first bay at a third orientation and the second bay at a fourth orientation.

7. The method of claim 6, wherein backtracking comprises associating the first time step with the first bay at the third orientation and the second bay at the fourth orientation.

8. The method of claim 6, wherein the third orientation differs from the first orientation by 1-3 degrees towards an imaginary horizontal line.

9. The method of claim 1, wherein intersection testing comprises determining whether any one of the rays intersects the second bay.

10. The method of claim 1, wherein the second bay is directly adjacent to the first bay along an east-west axis.

11. The method of claim 1, wherein the solar site array comprises a first tracker comprising the first bay and a second tracker comprising the second bay, the second tracker being directly adjacent to the first tracker.

12. The method of claim 11, further comprising, after backtracking at least one of the first bay and the second bay:
spawning a plurality of third rays towards a third bay of the bays, the third bay positioned at a fifth orientation of the orientations in the schedule, the third bay comprised in the first tracker to be directly adjacent to the first bay; and
intersection testing a fourth bay of the bays with the third rays, the fourth bay comprised in the second tracker to be directly adjacent to the second bay.

13. The method of claim 11, wherein the first tracker comprises more than two bays and the second tracker comprises more than two bays, further comprising, after backtracking at least one of the first and the second bay:
spawning a plurality of fourth rays towards all remaining bays in the first tracker other than the first bay; and
intersection testing all remaining bays in the second tracker other than the second bay with respective ones of the fourth rays.

14. The method of claim 1, further comprising, after backtracking:
spawning a plurality of fifth rays towards the first bay positioned at a third orientation of the orientations in the schedule, the third orientation associated with a second time step;
intersection testing the second bay using the fifth rays, the second bay positioned at a fourth orientation of the orientations in the schedule, the fourth orientation associated with the second time step;
backtracking at least one of the first bay and the second bay based on a result of the intersection testing.

15. The method of claim 1, wherein the schedule comprises a plurality of positions of a sun at the time steps, the positions comprising a first position of the sun at the first time step, and the sun and the second bay are on opposite sides of the first bay in the west-east axis.

16. A non-transitory, computer-readable storage medium storing computer-readable instructions which, when the instructions are executed on a processor, cause the processor to perform operations comprising:
obtaining elevation encoded location points that make up a plurality of bays of the solar site array;
calculating a schedule of tracking angles for the bays comprising a plurality of orientations for the bays;
spawning a plurality of rays towards a first bay of the bays, the first bay positioned at a first orientation of the orientations in the schedule;
intersection testing the second bay of the bays using the rays spawned for the first bay, the second bay being adjacent to the first bay; and
backtracking at least one of the first bay and the second bay based on a result of the intersection testing.

17. The non-transitory computer-readable medium of claim 16, wherein the schedule comprises time steps associated with the tracking angles, spawning the rays is done at a first time step of the time steps that is associated with the first orientation of the first bay, the schedule comprises a second orientation of the orientations associated with the first time step and the second bay, and intersection testing of the second bay is done as the second bay is positioned at the second orientation.

18. The non-transitory computer-readable medium of claim 16, wherein the schedule comprises a plurality of positions of a sun at the time steps, the positions comprising a first position of the sun at the first time step, and spawning the rays comprises tracing at most two rays from the first position of the sun respectively directed towards two upper corners of the first bay.

19. The non-transitory computer-readable medium of claim 16, wherein the first orientation is angled with respect to an imaginary horizontal line.

20. The non-transitory computer-readable medium of claim 16, wherein backtracking positions the first bay at a third orientation different from the first orientation, further comprising:
after backtracking, spawning a plurality of second rays towards the first bay positioned at the third orientation, and intersection testing the second bay using the second rays.
